(19) United States
(12) Patent Application Publication
(10) Pub. No.: US 2018/0121616 A1
(43) Pub. Date: May 3, 2018

(54) Systems and Methods for Treatment Decisions

(71) Applicant: Pinscriptive, Inc., San Juan Capistrano, CA (US)

(72) Inventors: Mark Lelinski, Austin, TX (US); Roni H. Amiel, Sparta, NJ (US)

(73) Assignee: PINSCRIPTIVE, INC.

(21) Appl. No.: 15/338,182

(22) Filed: Oct. 28, 2016

(51) Int. Cl. G06F 19/00

(52) U.S. Cl. CPC G06F 19/325; G06F 19/3456; G06F 19/3431; G06F 19/345

(57) ABSTRACT

A treatment decision system includes a computing platform having a hardware processor and a system memory storing a treatment evaluation software code including a treatment analysis module and a patient subpopulation-to-treatment matching module. The hardware processor is configured to execute the treatment evaluation software code to receive use case data and outcome history data for each of a number of treatments, to receive healthcare profiling data for a patient population diagnosed with a condition treatable using the treatments, to generate health status data for patient subpopulations within the patient population, to transform the use case data, the outcome history data, and the health status data into value scores corresponding respectively to a value of each of at least some of the treatments for treatment of the condition in the patient subpopulation included in the query, and to report the value score of the treatment included in the query.

### BACKGROUND

Advances in pharmaceutical and basic medical research have resulted in the availability of new medications and new treatment protocols that give hope to many patients who previously had faced a bleak health future. However, many of these cutting edge treatments are extremely costly, and leave insurers and other entities responsible for paying for patient care in the unenviable position of facing unsustainable costs, or restricting access to powerful and beneficial treatments.

For example, specialty pharmaceutical drugs being introduced for use in the treatment of cancer, cystic fibrosis, multiple sclerosis, rheumatoid arthritis, and hepatitis C may cost anywhere from approximately ten thousand to approximately one hundred thousand dollars for a full course of treatment. Moreover, the growth in cost of such specialty drugs is projected to by in the range of fifteen to twenty percent per year, thereby rapidly making already expensive treatments practically unaffordable. Despite their nearly prohibitive costs, however, these specialty drugs benefit the sickest, most severely ill patients, so that simply denying access to them due to their cost is not an appropriate solution.

One significant factor encouraging insurers and other healthcare payers to attempt to deny access to specialty drugs and other expensive treatment modalities is the cost associated with waste. Estimates of waste vary, but even conservative estimates suggest that up to twenty percent of expenditures on specialty drugs, for example, is waste. Waste typically occurs because of a mismatch between a prescribed drug or treatment method, and the patient receiving the treatment. For instance, certain individuals may have an adverse reaction to a drug, or may be relatively unresponsive to a particular treatment, where another patient would respond more favorably.

Unfortunately, the conventional approach of trial-and-error until a good match of patient to treatment is found is simply unworkably expensive for new and developing treatments, and may undesirably lead to the denial of treatments to patients who could greatly benefit from them. Consequently, there is a need for a treatment decision solution that can determine a substantially optimal match of a patient to a medication or other therapeutic treatment.

### SUMMARY

There are provided systems and methods for treatment decision, substantially as shown in and/or described in connection with at least one of the figures, and as set forth more completely in the claims.

### BRIEF DESCRIPTION OF THE DRAWINGS

FIG. 1 shows a diagram of an exemplary treatment decision system, according to one implementation;

FIG. 2 shows another exemplary implementation of a treatment decision system;

FIG. 3 shows an exemplary system and a computer-readable non-transitory medium including instructions for determining a treatment decision;

FIG. 4 is a flowchart presenting an exemplary method for use by a system for determining a treatment decision; and

FIG. 5 shows an exemplary value report for use in determining a treatment decision, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

As noted above, advances in pharmaceutical and basic medical research have resulted in the availability of new medications and new treatment protocols that give hope to many patients who previously had faced a bleak health future. However, and as also noted above, many of these cutting edge treatments are extremely costly, and leave insurers and other entities responsible for paying for patient care in the unenviable position of facing unsustainable costs, or restricting access to powerful and beneficial treatments.

The present application addresses the financial and ethical dilemmas described above, as well as analogous challenges in the provision of healthcare treatment, by providing treatment decision systems and methods designed to improve clinical outcomes for insurers and other healthcare payer entities, healthcare providers, and patients. According to one implementation, such a system and method may be used to reduce or eliminate waste by determining a substantially optimal match of a patient or patient subpopulation to a medication or other therapeutic treatment.

As disclosed in the present application, a treatment decision system includes a treatment decision platform having a hardware processor and a system memory storing a treatment evaluation software code. The treatment evaluation software code includes a treatment analysis module for determining a value score for a proposed drug or other treatment protocol, and a subpopulation-to-treatment matching module for determining a substantially optimized patient subpopulation-to-treatment match. The treatment decision system is configured to receive a query regarding use of a particular treatment for treating a diagnosed condition in a patient subpopulation, and to report a value score corresponding to the match quality of the queried treatment to the patient subpopulation. In addition, the treatment decision system can utilize the treatment evaluation software code to generate one or more “best value” treatment recommendations for alternative treatments having a higher value score than the treatment included in the query.

In some implementations, the treatments addressed by the disclosed treatment decision systems and methods may be relatively new prescription drugs, such as biologics or other costly specialty drugs. It is noted that for the purposes of the present application, a “biologic” or “biological medical product” is any pharmaceutical drug manufactured in, extracted from, or at least partially synthesized from biological sources, in contrast to traditional pharmaceutical drugs that are chemically synthesized. It is further noted that, as used herein, a “specialty drug” is a costly prescription medication, which may be chemically synthesized or produced as a biologic, and is used to treat complex, chronic conditions such as hepatitis C, cancer, multiple sclerosis, and rheumatoid arthritis, for example. The cost associated with use of a specialty drug may range from a few thousand dollars, up to approximately one hundred thousand dollars for a therapeutic course of treatment.

More generally, however, the treatment decision detenninations performed by the systems and according to the methods disclosed in the present application can be applied across a wide variety of treatment modalities. That is to say, in some implementations, the treatment decision systems and methods disclosed in the present application may be utilized to analyze and recommend treatments types other than specialty drug treatment, and/or may evaluate fundamentally different treatment modalities against one another. Examples of other treatment modalities include immunotherapy, gene therapy, proton therapy, robotic surgical technologies, and even the more conventional use of common prescription medications, as well as established chemotherapy and x-ray therapy protocols, to name a few.

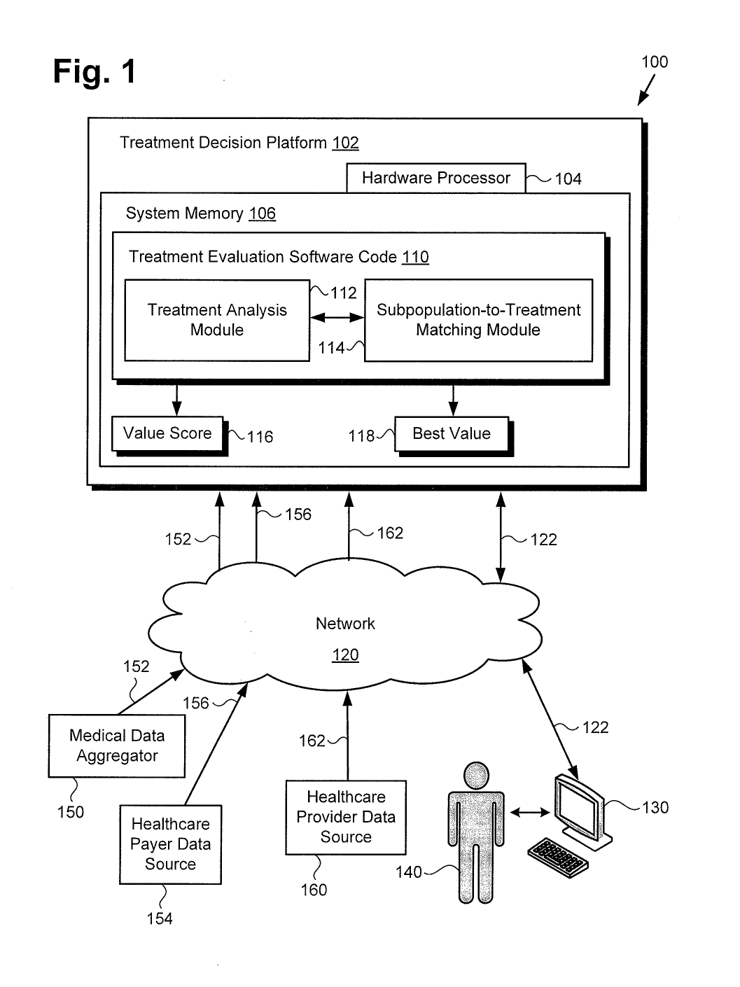

FIG. 1 shows a diagram of an exemplary treatment decision system, according to one implementation. Treatment decision system 100 includes treatment decision platform 102, which itself includes hardware processor 104 and system memory 106 storing treatment evaluation software code 110. As shown in FIG. 1, treatment evaluation software code 110 includes treatment analysis module 112 and patient subpopulation-to-treatment matching module 114. As further shown in FIG. 1, treatment decision system 100 is situated within a communications environment including network 120, client system 130, system user 140, medical data aggregator 150, healthcare payer data source 154, and healthcare provider data source 160. Also shown in FIG. 1 are value score 116, best value 118, network communication links 122 interactively connecting client system 130 with treatment decision platform 102, and aggregated data 152, payer data 156, and provider data 162 received by treatment decision platform 102 from medical data aggregator 150, healthcare payer data source 154, and healthcare provider data source 160, respectively.

According to the implementation shown in FIG. 1, system user 140 may utilize client system 130 to interact with treatment decision platform 102 over network 120. System user 140 may represent an insurer or other healthcare payer entity, and thus may be a utilization manager or coordinator, for example. Alternatively, system user 140 may be a healthcare provider, such as a physician, physician's assistant, pharmacist, or nurse practitioner, to name a few examples. System user 140 may utilize client system 130 to access treatment evaluation software code 110 remotely or to download treatment evaluation software code 110 to client system 130. In one such implementation, treatment decision platform 102 may correspond to one or more web servers, accessible over a packet network such as the Internet, for example. Alternatively, treatment decision platform 102 may correspond to one or more servers supporting a local area network (LAN), or included in another type of limited distribution network.

It is noted that although FIG. 1 depicts treatment analysis module 112 and patient subpopulation-to-treatment matching module 114 of treatment evaluation software code 110 as being mutually co-located in system memory 106, that representation is merely provided as an aid to conceptual clarity. More generally, treatment decision system 100 may include one or more treatment decision platforms 102, such as computer servers for example, which may be co-located, or may form an interactively linked but distributed system, such as a cloud based system, for instance. As a result, hardware processor 104 and system memory 106 may correspond to distributed processor and memory resources within treatment decision system 100. Thus, it is to be understood that treatment analysis module 112 and patient subpopulation-to-treatment matching module 114 may be stored remotely from one another within the distributed memory resources of treatment decision system 100.

Hardware processor 104 is configured to execute treatment evaluation software code 110 to receive use case data and outcome history data for each of multiple treatments, such as pharmaceutical drugs, for example. According to various implementations of the present treatment decision system, any or all of aggregated data 152, payer data 156, and provider data 162, received respectively from medical data aggregator 150, healthcare payer data source 154, and healthcare provider data source 160, can include such use case data and outcome history data.

For example, aggregated data 152 may include both payer data as described in 156 and provider data as described in 162. This aggregated data may or may not be linked at the patient level. Payer data 156 may include claims data obtained from insurers or other healthcare payer entities, and may describe claims history for patients for whom any of the multiple treatments has been prescribed, as well as the costs associated with those treatments. Provider data 162 may include electronic medical records or laboratory data for patients having been treated using any of the multiple treatments, for example, which may have been redacted to protect the identities of individual patients.

Hardware processor 104 is further configured to execute treatment evaluation software code 110 to receive healthcare profiling data for a patient population diagnosed with a condition treatable using the treatments for which use case data and outcome history data have been received. Once again, any or all of aggregated data 152, payer data 156, and provider data 162 can include the healthcare profiling data.

Hardware processor 104 is also configured to execute treatment evaluation software code 110 to generate health status data for patient subpopulations within the general patient population for which healthcare profiling data was received. For example, hardware processor 104 may execute treatment evaluation software code 110 to segregate a patient population diagnosed with a particular condition into patient subpopulations associated with health status data in the fonn of a patient genotype common to the patient subpopulation, a treatment previously received for the condition by members of the patient subpopulation, and the presence or absence of complications or aggravating factors in common for members of the patient subpopulation.

In one exemplary implementation, treatment decision system 100 may receive a query from system user 140 of client system 130, via network 120. Such a query may regard suitability of use of one of the treatments for which use case data and outcome history data have been received, by one or more of the patient subpopulations for which health status data has been generated, for treatment of a particular condition.

In response to such a query, hardware processor 104 is configured to execute treatment evaluation software code 110 to utilize treatment analysis module 112 to transform the use case and outcome history data, and the health status data into value scores corresponding respectively to a value of at least some of the treatments for treatment of the queried condition in the queried patient subpopulation. For example, hardware processor 104 may be configured to execute treatment evaluation software code 110 to utilize treatment analysis module 112 to determine value score 116 for the treatment included in the query, as well as one or more value scores corresponding respectively to alternative treatments. Hardware processor 104 is further configured to execute treatment evaluation software code 110 to report value score 116 for the treatment included in the query.

In addition, in some implementations, hardware processor 104 may be configured to execute treatment evaluation software code 110 to utilize patient subpopulation-to-treatment matching module 114 to generate one or more treatment recommendations, corresponding to best value 118, for any treatments having a higher value score than the treatment included in the query.

It is noted that although FIG. 1 depicts value score 116 and best value 118 as residing in system memory 106, in some implementations, value score 116 and/or best value 118 may be copied to non-volatile storage (not shown in FIG. 1), or may be transmitted to client system 130 via network 120. It is further noted that although client system 130 is shown as a personal computer (PC) in FIG. 1, that representation is provided merely as an example. In other implementations, client system 130 may be another type of personal communication device, such as a smartphone or tablet computer, for example.

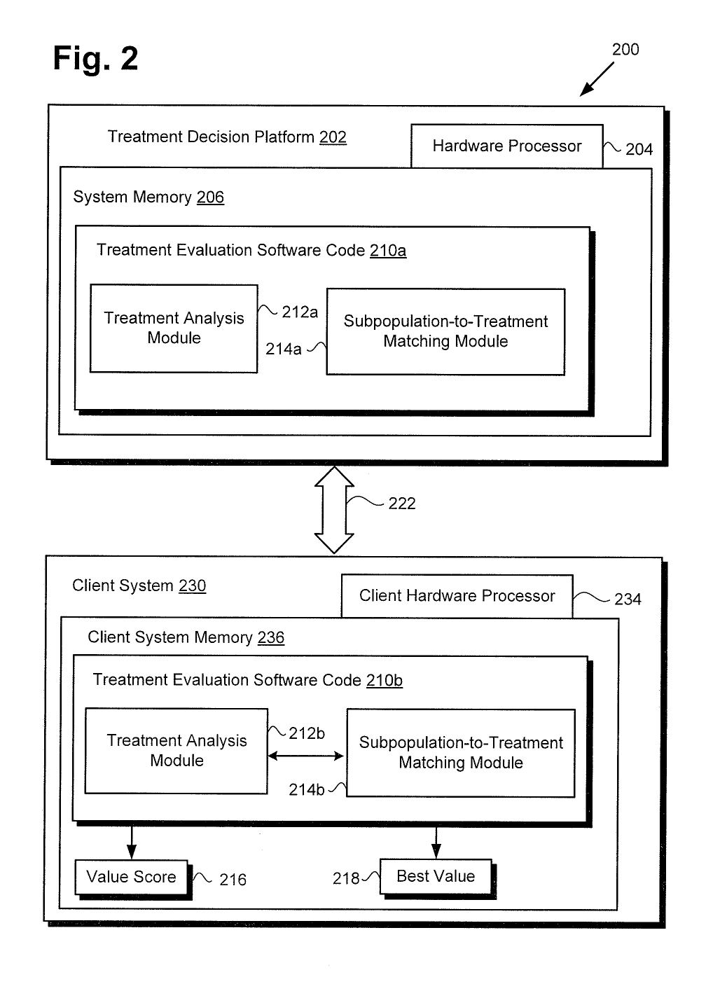

FIG. 2 shows an exemplary implementation of treatment decision system 200 in combination with a more detailed representation of client system 230. Treatment decision system 200 includes treatment decision platform 202, which is shown to be interactively connected to client system 230 over network communication link 222. Treatment decision platform 202 includes hardware processor 204, and system memory 206 storing treatment evaluation software code 210a. As shown in FIG. 2, treatment evaluation software code 210a includes treatment analysis module 212a and patient subpopulation-to-treatment matching module 214a. As further shown in FIG. 2, client system 230 includes client hardware processor 234, and client system memory 236 storing treatment evaluation software code 210b including treatment analysis module 212b and patient subpopulation-to-treatment matching module 214b. Also shown in FIG. 2 are value score 216 and best value 218 determined by client system 230.

Network communication link 222, and treatment decision system 200 including treatment decision platform 202 having hardware processor 204 and system memory 206 correspond in general to network communication link 122, and treatment decision system 100 including treatment decision platform 102 having hardware processor 104 and system memory 106, in FIG. 1, and may share any of the characteristics attributed to those corresponding features in the present application. In addition, treatment evaluation software code 210a including treatment analysis module 212a and patient subpopulation-to-treatment matching module 214a, in FIG. 2, corresponds in general to treatment evaluation software code 110 including treatment analysis module 112 and patient subpopulation-to-treatment matching module 114, in FIG. 1. In other words, treatment evaluation software code 210a, treatment analysis module 212a, and patient subpopulation-to-treatment matching module 214a may share any of the characteristics attributed to corresponding treatment evaluation software code 110, treatment analysis module 112, and patient subpopulation-to-treatment matching module 114 in the present application.

Client system 230 corresponds in general to client system 130, in FIG. 1. Moreover, treatment evaluation software code 210b including treatment analysis module 212b and patient subpopulation-to-treatment matching module 214b corresponds in general to treatment evaluation software code 110/210a including treatment analysis module 112/212a and patient subpopulation-to-treatment matching module 114/214a. As a result, treatment evaluation software code 210b, treatment analysis module 212b, and patient subpopulation-to-treatment matching module 214b may share any of the characteristics attributed to corresponding treatment evaluation software code 110, treatment analysis module 112, and patient subpopulation-to-treatment matching module 114 in the present application.

According to the exemplary implementation shown in FIG. 2, treatment evaluation software code 210b including treatment analysis module 212b and patient subpopulation-to-treatment matching module 214b is located in client system memory 236, having been received from treatment decision platform 202 via network communication link 222. In one implementation, network communication link 222 corresponds to transfer of treatment evaluation software code 210b including treatment analysis module 212b and patient subpopulation-to-treatment matching module 214b over a packet network, for example. Once transferred, for instance by being downloaded over network communication link 222, treatment evaluation software code 210b including treatment analysis module 212b and patient subpopulation-to-treatment matching module 214b may be persistently stored in client system memory 236 and may be executed locally on client system 230 by client hardware processor 234.

Client hardware processor 234 may be the central processing unit (CPU) for client system 230, for example, in which role client hardware processor 234 runs the operating system for client system 230 and executes treatment evaluation software code 210b. In the exemplary implementation of FIG. 2, a user of client system 230, such as system user 140, in FIG. 1, can utilize treatment evaluation software code 210b on client system 230 to determine value score 216 and best value 218, which correspond respectively to value score 116 and best value 118, in FIG. 1. Thus, according to the exemplary implementation shown in FIG. 2, client system 230 may function analogously to treatment decision platform 102/202 and, like treatment decision platform 102/202, may be utilized to determine treatment decisions.

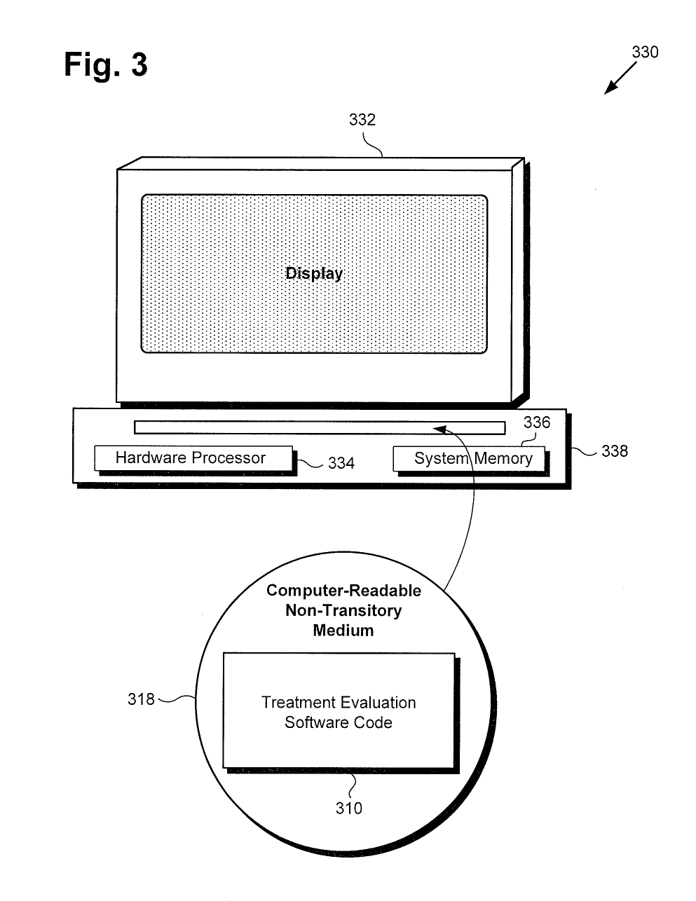

FIG. 3 shows an exemplary system and a computer-readable non-transitory medium including instructions for determining a treatment decision, according to one implementation. System 330, in FIG. 3, includes computer 338 having hardware processor 334 and system memory 336, interactively linked to display 332. Display 332 may take the form of a liquid crystal display (LCD), a light-emitting diode (LED) display, an organic light-emitting diode (OLED) display, or another suitable display screen that performs a physical transformation of signals to light. System 330 including hardware processor 334 and system memory 336 corresponds in general to any or all of treatment decision platform 102 and client system 130, in FIG. 1, and treatment decision platform 202 and client system 230, in FIG. 2.

Also shown in FIG. 3 is computer-readable non-transitory medium 318 having treatment evaluation software code 310 stored thereon. The expression “computer-readable non-transitory medium,” as used in the present application, refers to any medium, excluding a carrier wave or other transitory signal, that provides instructions to hardware processor 334 of computer 338. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory media include, for example, optical discs, RAM, programmable read-only memory (PROM), erasable PROM (EPROM), and FLASH memory.

According to the implementation shown in FIG. 3, computer-readable non-transitory medium 318 provides treatment evaluation software code 310 for execution by hardware processor 334 of computer 338. Treatment evaluation software code 310 corresponds in general to treatment evaluation software code 110/210a/210b, in FIGS. 1/2, and is capable of performing all of the operations attributed to those corresponding features by the present disclosure. In other words, treatment evaluation software code 310 includes a treatment analysis module (not shown in FIG. 3) and a patient subpopulation-to-treatment matching module (also not shown in FIG. 3) corresponding respectively to treatment analysis module 112/212a/212b and patient subpopulation-to-treatment matching module 114/214a/214b.

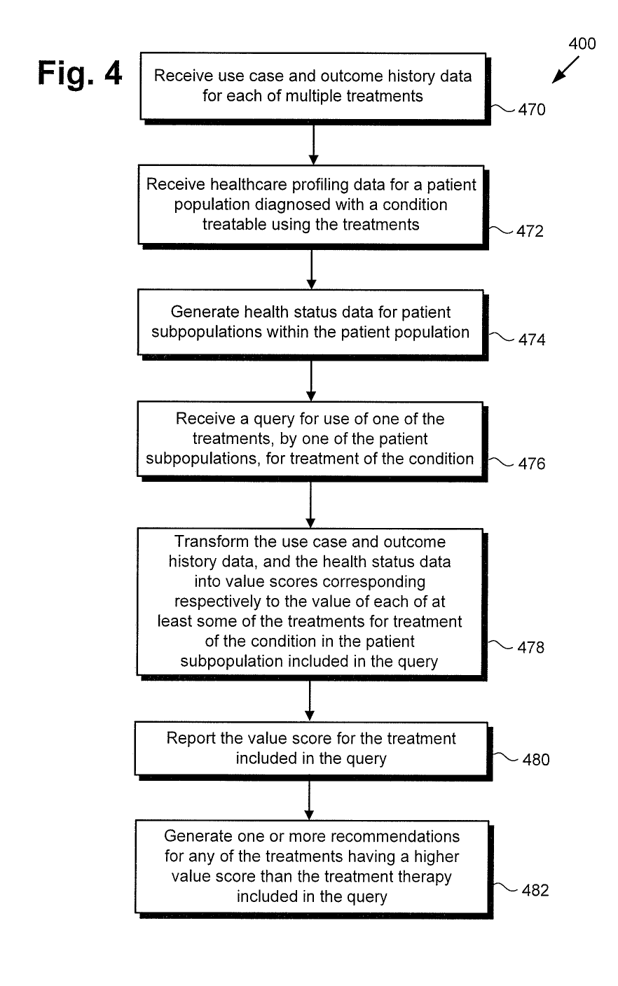

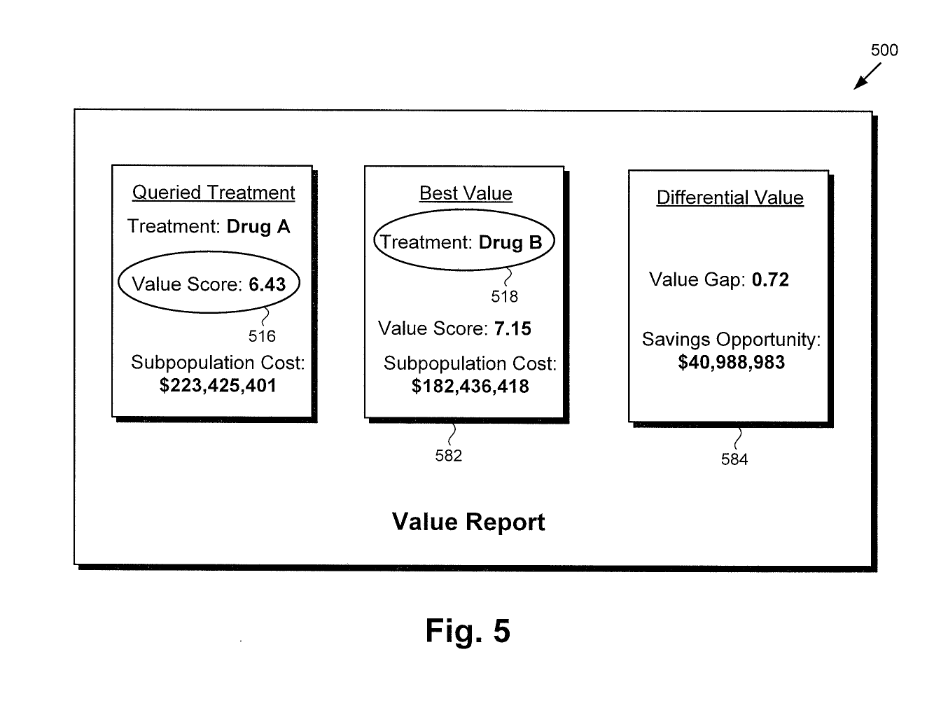

The systems suitable for use as treatment decision systems and discussed above by reference to FIGS. 1, 2, and 3, will be further described below with reference to FIG. 4 and FIG. 5. FIG. 4 presents flowchart 400 outlining an exemplary method for use by a system for determining a treatment decision, while FIG. 5 shows an exemplary value report for use in determining a treatment decision, according to one implementation.

Flowchart 400 begins with receiving use case data and outcome history data for each of one or more treatments (action 470). Referring to FIG. 1, and as noted above, any or all of aggregated data 152, payer data 156, and provider data 162, received respectively from medical data aggregator 150, healthcare payer data source 154, and healthcare provider data source 160, can include the use case data and the outcome history data. Aggregated data 152 and/or payer data 156 and/or provider data 162 may be received by treatment evaluation software code 110/210a/210b/310 of system 100/200/230/330, executed by hardware processor 104/204/234/334. As shown in FIG. 1, aggregated data 152, payer data 156, and provider data 162 may be received by treatment evaluation software code 110/210a/210b/310 from respective medical data aggregator 150, healthcare payer data source 154, and healthcare provider data source 160 via network 120.

Use case data may be data describing the circumstances surrounding application of a particular treatment. Use case data may include the condition being treated, the progression or staging of the condition, the particular treatment chosen, and a duration and/or a drug dosage used to treat the condition, to name a few examples. Outcome history data may be data recording the outcome of a treatment applied in a particular use case. Thus, outcome history data may include the remission or recurrence of the condition, a response timeline of the condition to the treatment, or a result of the treatment, such as recovery of the patient, death of the patient, or abandonment of the treatment, to name a few examples. In addition, outcome history data may include data derived from clinical trials of a particular treatment, and may include risks and other patient safety information obtained during the course of such clinical trials.

As further noted above, the one or more treatments for which the use case data and the outcome history data may be received can include prescription drug treatments, including drug treatments utilizing biologics and other costly specialty drugs. However, as an alternative to, or in addition to, drug treatments, other treatments for which the use case data and the outcome history data may be received include immunotherapy, gene therapy, proton therapy, robotic surgical technologies, and even the more conventional use of common prescription medications, as well as established chemotherapy and x-ray therapy protocols, for example.

Flowchart 400 continues with receiving healthcare profiling data for a patient population diagnosed with a condition treatable using the one or more treatments for which use case data and outcome history data have been received (action 472). Any or all of aggregated data 152, payer data 156, and provider data 162 can include the healthcare profiling data, as well as the use case data and the outcome history data discussed by reference to action 470. As stated above, aggregated data 152 and/or payer data 156 and/or provider data 162 may be received by treatment evaluation software code 110/210a/210b/310 of system 100/200/230/330, executed by hardware processor 104/204/234/334. As further stated above, aggregated data 152, payer data 156, and provider data 162 may be received by treatment evaluation software code 110/210a/210b/310 via network 120.

Healthcare profiling data may be data describing individual patients of a patient population having a diagnosis in common. For example, healthcare profiling data may include the age, gender, general health, and genotype of patients diagnosed with a condition treatable by the treatments for which use case data and outcome history data have been received. In addition, health care profiling data can include any other patient characteristics considered to be relevant to a particular diagnosis.

Flowchart 400 continues with generating health status data for patient subpopulations within the patient population (action 474). The generation of the health status data can be performed by treatment evaluation software code 110/210a/210b/310 of system 100/200/230/330, executed by hardware processor 104/204/234/334.

As a specific but non-limiting example presented for the purposes of conceptual clarity, in a particular implementation in which the diagnosed condition treatable using the treatments for which use case data and outcome history data have been received is hepatitis C, health status data for segregating patient subpopulations within the patient population diagnosed with hepatitis C may include several parameters. For instance, health status data for a particular patient subpopulation diagnosed with hepatitis C may include the genotype common to the patient subpopulation, whether the patients having the genotype in common have previously received some form of treatment for hepatitis C, and whether the patients having the genotype in common and sharing a common treatment history have presented with cirrhosis of the liver (hereinafter “cirrhosis”).

For the exemplary implementational situation described above, four different subpopulations of patients having the same genotype can give rise to four different sets of health status data corresponding to those subpopulations: (1) patients not previously receiving some form of hepatitis C treatment and without cirrhosis, (2) patients not previously receiving some form of hepatitis C treatment and presenting with cirrhosis, (3) patients having previously received some form of hepatitis C treatment and without cirrhosis, and (4) patients having previously received some form of hepatitis C treatment and presenting with cirrhosis.

Each distinct genotype could analogously contribute to four different sets of health status data corresponding to four patient subpopulations. Thus, for the exemplary hepatitis C focused implementation discussed above, hardware processor 104/204/234/334 may execute treatment evaluation software code 110/210a/210b/310 of system 100/200/230/330 to generate health status data for each distinct combination of genotype, presence or absence of previous hepatitis C treatment history, and presence or absence of cirrhosis.

As a specific exemplary use case, for the hepatitis C focused implementation discussed above, health status data may be generated for thirty-two (32) distinct patient subpopulations within the patient population having hepatitis C as a common diagnosis. An exemplary list of those 32 patient subpopulations, as well as exemplary parameters for distinguishing among the subpopulations, is provided as Appendix A of the present application. It is noted, however, that in other implementations, the health status data generated by treatment evaluation software code 110/210a/210b/310 may include more parameters, such as many more parameters, than the exemplary three parameters described above. Moreover, in implementations focused on treatment of other conditions, health status data may be generated for more, or fewer, than the exemplary 32 distinct patient subpopulations identified for hepatitis C and listed in Appendix A.

It is further noted that the number of parameters included in the health status data generated by treatment evaluation software code 110/210a/210b/310 in action 474, as well as the number of identified patient subpopulations, can evolve as treatment evaluation software code 110/210a/210b/310 engages in machine learning. In other words, hardware processor 104/204/234/334 may further execute treatment evaluation software code 110/210a/210b/310 to adapt and improve its treatment decision modeling functionality in response to future aggregated data 152 and/or payer data 156 and/or provider data 162 received from respective medical data aggregator 150 and/or healthcare payer data source 154 and/or healthcare provider data source 160.

Flowchart 400 continues with receiving a query regarding use of one of the treatments for which the use case data and the outcome history data have been received, by one of the patient subpopulations, for treatment of the condition common to members of the patient subpopulation (action 476). Such a query may be received by treatment evaluation software code 110/210a/210b/310 of system 100/200/230/330, executed by hardware processor 104/204/234/334. For example, in the case of treatment evaluation software code 110/210a executed by hardware processor 104/204, the query may be received via network 120, over network communication link 122/222. Alternatively, in the case of treatment evaluation software code 210b/310 executed by hardware processor 234/334, the query may be received via inputs from system user 140 to client system 130/230 or to system 330.

The query may include identification of the treatment under consideration for use, the condition for which the treatment is being considered as a therapy, and patient data sufficient to evaluate the treatment relative to a particular patient subpopulation. For example, the patient data may include data describing a single patient, may include the health status data associated with a particular patient subpopulation as discussed above, or may identify a patient subpopulation expressly. Continuing with the hepatitis C focused exemplary implementation introduced above, a query received by treatment evaluation software code 110/210a/210b/310 executed by hardware processor 104/204/234/334, may be with respect to drug treatment for hepatitis C in a particular patient subpopulation using “Drug A.”

Flowchart 400 continues with transforming the use case data, the outcome history data, and the health status data into value scores corresponding respectively to a value of each of at least some of the treatments for which the use case data and the outcome history data have been received, for treatment of the condition in the patient subpopulation included in the query (action 478). Transformation of the use case data, the outcome history data, and the health status data into value scores may be performed by treatment evaluation software code 110/210a/210b/310 of system 100/200/230/330, executed by hardware processor 104/204/234/334, and using treatment analysis module 112/212a/212b.

In some implementations, the transformation of the use case data, the outcome history data, and the health status data into a value score for a particular treatment, such as value score 116/216 may be based on a combination of an efficacy of the treatment, an adherence of the treatment, and a cost of the treatment in the patient subpopulation included in the query, for example.

For the purposes of the present application, treatment efficacy, or simply “efficacy” (E), is a measure of the effectiveness of the treatment based on real world evidence. Efficacy is defined as the percentage of patients within a particular patient subpopulation for whom remission or recovery occurs after completion of the treatment protocol. Returning to the example in which a query regarding use of Drug A for treatment of hepatitis C in a particular patient subpopulation has been received, efficacy may be expressed as follows:

E (%)=N_{SVR}_{_}₁₂_{_}₀/N_{SP}*100 (Equation 1)

Where: SVR 12 is the Sustained Virological Response on a gap of twelve weeks after completion of a prescribed treatment period, N_{SVR}_{_}₁₂_{_}₀ is the number of patients within a subpopulation for whom SVR 12 is substantially zero, or negligible, and N_{SP} is the total number of patients in the patient subpopulation receiving the treatment. Treatment adherence, or simply “adherence” (A), is a measure of the degree with which patients tend to comply with a particular treatment. In the case of drug treatment, one measure of adherence is the ratio of the drug dosage actually consumed by patients over a treatment period to the prescribed dosage over the treatment period. It is noted that adherence is an aggregated measure across all patients within a subpopulation receiving the same treatment. For example, adherence with respect to a drug treatment may be determined using the medication possession ratio (MPR), as known in the art, for a patient subpopulation treated using the same drug.

Treatment cost, or simply “cost” (C) is the cost of the treatment over the prescribed treatment period. For example, the cost of a drug treatment administered daily for ten weeks is the cumulative cost of the entire prescribed drug dosage over the ten week treatment period.

Value score (V) 116/216 of a particular treatment may be determined using a weighted or non-weighted combination of efficacy, adherence, and cost, as follows:

V=(w₁*E+w₂*A+w₃*C)/[100*(w₁+w₂+w₃)]*10 (Equation 2)

Where w₁, w₂, and w₃, are fractional weighting factors in a range between zero and one, inclusive of one, and are applied respectively to efficacy, adherence, and cost. It is noted that where value score 116\216 is determined using a non-weighted combination of efficacy, adherence, and cost, each of w₁, w₂, and w₃ may be set equal to one (w₁=w₂=w₃=1). It is further noted that in implementations in which value score 116/216 is determined using a weighted combination of efficacy, adherence, and cost, the weighting factors w₁, w₂, and w₃ may be predetermined and fixed within treatment evaluation software code 110/210a/210b/310, or may be selectable or adjustable by a user, such as system user 140. That is to say, in some implementations, system user 140 may have discretion to increase or reduce weighting factors w₁, w₂, and w₃ relative to one another.

In addition to efficacy, adherence, and cost, in some implementations, value score 116/216 may be further determined based on a safety record of the treatment in the patient subpopulation included in the query and/or overall utilization of the treatment among members of the patient subpopulation, for example. Treatment safety, or simply “safety,” may be determined based on the rate at which known complications of a particular treatment have historically manifested themselves in the patient subpopulation. Moreover, in some implementations, safety may be determined based on the costs associated with intervening to remedy those complications, or with a hospitalization rate of members of the patient subpopulation during or immediately after the treatment.

Treatment utilization, or simply “utilization” (U), is defined as the number of patients within a given patient subpopulation to whom a particular treatment has been prescribed, divided by the total number of patients making up the patient subpopulation. Thus, utilization of treatment “X” may be expressed as a percentage as follows:

U_{X} (%)=N_{X}/N_{TSP}*100 (Equation 3)

Where: N_{X} is the number of patients within the patient subpopulation to whom treatment X has been prescribed, and N_{TSP} is the total number of patients making up the patient subpopulation. It is noted that Equation 2 can be modified to include weighted or non-weighted contributions based on safety and/or utilization.

Thus, it is emphasized that in some implementations, system user 140 may select the variables included in Equation 2 and used to determine value score 116/216, and/or may select the weighting applied to the included variables by Equation 2. As a result, treatment evaluation software code 110/210a/210b/310 may be executed by hardware processor 104/204/234/334 to evaluate a queried treatment in a way that balances the interests of the different parties, i.e., insurers or other healthcare payer entities, healthcare providers, and patients, affected by the resulting treatment decision.

In some implementations, flowchart 400 may conclude with reporting value score 116/216 for the treatment included in the query (action 480). However, in other implementations, the method of flowchart 400 may continue with generating one or more treatment recommendations for any treatment having a higher value score than the treatment included in the query, i.e., higher than value score 116/216 (action 482).

Value score 116/216 may be reported by treatment evaluation software code 110/210a/210b/310 of system 100/200/230/330, executed by hardware processor 104/204/234/334. Referring to FIG. 5, FIG. 5 shows exemplary value report 500 for use in determining a treatment decision, and including value score 516 for Drug A included in the exemplary query described above. As shown in FIG. 5, according to value report 500, value score 116/216/516 for Drug A used in the treatment of hepatitis C in a particular patient subpopulation is 6.43. Moreover, the cost attributable to use of Drug A across the patient subpopulation is reported to be $223,425,401.00.

In implementations in which treatment recommendation 582 identifying best value 118/218/518 is generated in action 482, that treatment recommendation 582 may be included in value report 500. Treatment recommendation 582 may be generated by, and best value 118/218/518 may be determined by, treatment evaluation software code 110/210a/210b/310 of system 100/200/230/330, executed by hardware processor 104/204/234/334, and using patient subpopulation-to-treatment matching module 114/214a/214b.

As shown in FIG. 5, treatment recommendation 582 identifies alternative Drug B as best value 118/218/518 having a higher value score of 7.15 than value score 116/216/516 of 6.43 for Drug A included in the query. In addition to the value score for best value 118/218/518, treatment recommendation 582 includes the cost attributable to use of best value 118/218/518 Drug B across the patient subpopulation, which is reported to be $182,436,418.00.

As further shown in FIG. 5, in some implementations, value report 500 may also include differential value 584 which shows the value gap separating queried Drug A and best value 118/218/518 Drug B, as well as the savings opportunity across the patient subpopulation if best value 118/218/518 Drug B is prescribed for use rather than queried Drug A. According to exemplary value report 500, best value 118/218/518 Drug B has a value score that is 0.72 higher than value score 116/216/516 of queried Drug A. Moreover, according to value report 500, over forty million dollars in savings can be realized by an insurer or other healthcare payer entity if best value 118/218/518 Drug B is substituted for queried Drug A for treatment of hepatitis C in the patient subpopulation.

Thus, the systems and methods disclosed in the present application address serious financial and ethical dilemmas posed by decisions to permit or deny patient access to extremely costly but highly therapeutic treatments. The disclosed systems and methods may be used to advantageously reduce or eliminate waste by determining a substantially optimal match of a patient or patient subpopulation to a medication or other therapeutic treatment. Consequently, the systems and methods disclosed in the present application can play an important role in enabling seriously and/or chronically ill patients to have greater access to effective treatments for the conditions that afflict them, thereby improving clinical outcomes for insurers, healthcare providers, and patients alike.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A treatment decision system comprising:
a computing platform including a hardware processor and a system memory;
a treatment evaluation software code stored in the system memory, the treatment evaluation software code including a treatment analysis module and a subpopulation-to-treatment matching module;
wherein the hardware processor is configured to execute the treatment evaluation software code to:
receive use case data and outcome history data for each of a plurality of treatments;
receive healthcare profiling data for a patient population diagnosed with a condition treatable using the plurality of treatments;
generate health status data for patient subpopulations within the patient population;
receive a query for use of one of the plurality of treatments, by one of the patient subpopulations, for treatment of the condition;
transform the use case data, the outcome history data, and the health status data into value scores corresponding respectively to a value of each of at least some of the plurality of treatments for treatment of the condition in the patient subpopulation included in the query; and
report the value score for the treatment included in the query.

2. The treatment decision system of claim 1, wherein the hardware processor is further configured to execute the treatment evaluation software code to generate one or more treatment recommendations for any of the plurality of treatments having a higher value score than the treatment included in the query.

3. The treatment decision system of claim 1, wherein the treatments comprise prescription drugs.

4. The treatment decision system of claim 1, wherein the treatments comprise specialty drugs.

5. The treatment decision system of claim 1, wherein the treatments comprise biologics.

6. The treatment decision system of claim 1, wherein the use case data, the outcome history data, and the health status data are transformed into a value score for a treatment based on a combination of an efficacy of the treatment, an adherence of the treatment, and a cost of the treatment in the patient subpopulation included in the query.

7. The treatment decision system of claim 6, wherein the value score of the treatment is further determined based on a safety record of the treatment in the patient subpopulation included in the query.

8. A method for use by a system for determining a treatment decision, the system comprising a computing platform including a hardware processor and a system memory having a treatment analysis module and a subpopulation-to-treatment matching module stored therein, the method comprising:
receiving, using the hardware processor, use case data and outcome history data for each of a plurality of treatments;
receiving, using the hardware processor, healthcare profiling data for a patient population diagnosed with a condition treatable using the plurality of treatments;
generating, using the hardware processor, health status data for patient subpopulations within the patient population;
receiving, using the hardware processor, a query for use of one of the plurality of treatments, by one of the patient subpopulations, for treatment of the condition;
transforming, using hardware processor, the use case data, the outcome history data, and the health status data into value scores corresponding respectively to a value of each of at least some of the plurality of treatments for treatment of the condition in the patient subpopulation included in the query; and
reporting, using the hardware processor, the value score for the treatment included in the query.

9. The method of claim 8, further comprising generating, using the hardware processor, one or more treatment recommendations for any of the plurality of treatments having a higher value score than the treatment included in the query.

10. The method of claim 8, wherein the treatments comprise prescription drugs.

11. The method of claim 8, wherein the treatments comprise specialty drugs.

12. The method of claim 8, wherein the treatments comprise biologics.

13. The method of claim 8, wherein transforming the use case data, the outcome history data, and the health status data into a value score for a treatment is based on a combination of an efficacy of the treatment, an adherence of the treatment, and a cost of the treatment in the patient subpopulation included in the query.

14. The method of claim 9, wherein transforming the use case and outcome history data, and the health status data into the value score for the treatment is further based on a safety record of the treatment in the patient subpopulation included in the query.

15. A computer-readable non-transitory medium having stored thereon instructions, which when executed by a hardware processor, instantiate a method comprising:
receiving use case data and outcome history data for each of a plurality of treatments;
receiving healthcare profiling data for a patient population diagnosed with a condition treatable using the plurality of treatments;
generating health status data for patient subpopulations within the patient population;
receiving a query for use of one of the plurality of treatments, by one of the patient subpopulations, for treatment of the condition;
transforming the use case data, the outcome history data, and the health status data into value scores corresponding respectively to a value of each of at least some of the plurality of treatments for treatment of the condition in the patient subpopulation included in the query; and
reporting the value score for the treatment included in the query.

16. The computer-readable non-transitory medium of claim 15, wherein the method further comprises generating one or more treatment recommendations for any of the plurality of treatments having a higher value score than the treatment included in the query.

17. The computer-readable non-transitory medium of claim 15, wherein the treatments comprise prescription drugs.

18. The computer-readable non-transitory medium of claim 15, wherein the treatments comprise specialty drugs.

19. The computer-readable non-transitory medium of claim 15, wherein the treatments comprise biologics.

20. The computer-readable non-transitory medium of claim 15, wherein transforming the use case data, the outcome history data, and the health status data into a value score for a treatment is based on a combination of an efficacy of the treatment, an adherence of the treatment, and a cost of the treatment in the patient subpopulation included in the query.
